(19) United States
(12) Patent Application Publication
(10) Pub. No.: US 2007/0285062 A1
(43) Pub. Date: Dec. 13, 2007

(54) Lithium-ion Battery Protection Method and Device

(76) Inventors: Jing-Yih Cherng, Tao-Yuan (TW); Wei-Chen Wu, Tao-Yuan (TW); Steven Hou, Tao-Yuan (TW)

Correspondence Address: HDSL, 4331 STEVENS BATTLE LANE, FAIRFAX, VA, 22033, US

(21) Appl. No.: 11/423,205

(22) Filed: Jun. 9, 2006

(51) Int. Cl. H02J 7/00

(52) U.S. Cl. 320/136

(57) ABSTRACT

A lithium-ion battery protection method and device controls an externally connected circuit to charge/discharge a rechargeable battery so as to prevent the rechargeable battery from over charging/discharging. The lithium-ion-ion battery protection device includes an abnormality detection circuit, a light coupling circuit, a balancing circuit, and a recognition circuit. The abnormality detection circuit is to detect the voltage of the lithium-ion-ion battery and output a detection signal. The battery continues to charge/discharge if the signal is normal, and terminate to charge/discharge if the signal is abnormal. Then, the balancing circuit determines whether the detection signal is an overcharged signal, and if yes, the rechargeable battery is discharged accordingly. Meanwhile, the light coupling circuit adjusts an impedance of the light coupling circuit based on the detection signal so as to break the connection between the rechargeable battery and the externally connected circuit, and the recognition circuit outputs signal identifying location of the battery.

### BACKGROUND OF THE INVENTION

1. Field of the Invention

The present invention relates to a control circuit for a series-parallel battery array, and in particular, to a lithium-ion battery protection method and device.

2. Description of Prior Art

Ni-Cd and Ni-MH batteries are popular rechargeable batteries for portable electronics. NiCd batteries are considered technology of the past generation and are now less seen on the market due to the profound memory effects and short battery lifespan, not to mention that Cadmium is a heavy metal and an environmental hazard. Given the NiCd shortcomings, NiMH batteries have thus been developed to reduce memory effects, increase storage capacity, prevail against over charging and discharging, and increase battery lifespan. NiMH batteries also require less charging time, and more importantly, do not use heavy metals and thus greatly reduce environmental pollution. However, NiMH batteries are yet to be a perfect solution. Namely, they are poor in adapting to the environment and cease to operate above 45° C. or below 0° C. Also, NiMH batteries tend to self-discharge if left idle for a long period after a full charge.

Another popular type of rechargeable battery is the lithium-ion batteries, which provide as good alternatives to both NiCd and NiMH batteries with no memory effects and a slow self-discharge rate. However, lithium-ion batteries aren't without drawbacks.

When under charge, lithium-ion batteries are susceptible to explosion if the charge voltage is too high; on the other hand, when under discharge, the lifespan of lithium-ion batteries can be greatly reduced if the discharge voltage is so low that the voltage of lithium-ion batteries reaches below a threshold voltage level. To address problems incurred during charging and discharging, a common approach is to add a protection device to the lithium-ion batteries, as shown in FIG. 1.

FIG. 1 shows illustration of a protection device for lithium-ion batteries. For illustration, four serially connected lithium-ion batteries are shown. Protection device 100 includes a protection IC101 designed specifically for a four serially connected rechargeable battery array, and a circuit switch 103. During the design phase of the circuit, the appropriate protection IC (Integrated Circuit) 101 is chosen based on the number of serially connected lithium-ion batteries present. In operation, protection IC 101 is to detect the voltage of each of the serially connected lithium-ion batteries 102 during battery charging/discharging. When a voltage abnormality is detected, protection IC 101 sends out signals to circuit switch 103, and in response, the circuit switch 103 is opened to terminate further current charging or discharging, and thereby giving battery protection. Given the dependence on battery numbers, a new protection device 100 must be manufactured specifically for every battery array when the number of sequentially connected lithium ion batteries 102 varies. However, current manufacturers only provide protection ICs 101 that can adapt a maximum of four serially connected lithium-ion batteries, and any increase in the number of the serially connected lithium-ion batteries means an increase in complexity of the circuit design of protection IC 101. Thus, due to the different battery aging rates and circuit complexity, manufacturing a lithium-ion battery protection device of more than five serially connected batteries is an extremely difficult task.

### SUMMARY OF THE INVENTION

The present invention is to prevent the afore-mentioned problems. The invention eliminates the problems by redesigning the rechargeable battery protection device to operate regardless of the number of serially connected lithium-ion batteries in presence, which is achieved by parallelly connecting each lithium-ion battery to the same circuit board having an interconnected interface. When any battery is experiencing abnormality, a signal is generated to inform the system of the location of the battery that's experiencing abnormality, or the circuit switch is opened to terminate the current from charging or discharging.

The invention is to utilize the parallelly connected circuit board to determine whether a battery is experiencing abnormality and to discharge said overcharged battery accordingly, thus micro-tuning each of the serially connected batteries to achieve circuit balance.

The invention is to easily add or remove batteries from the array of serially connected lithium-ion batteries without the need of re-manufacturing circuit boards, but rather, by simple external wiring.

The lithium-ion battery protection device according to the invention controls an externally connected circuit to charge/discharge a rechargeable battery so as to prevent the rechargeable battery from over charging/discharging. The lithium-ion-ion battery protection device includes an abnormality detection circuit, a light coupling circuit, a balancing circuit, and a recognition circuit. The abnormality detection circuit is to detect the voltage of the lithium-ion-ion battery and output a detection signal. The battery continues to charge/discharge if the signal is normal, and terminate to charge/discharge if the signal is abnormal. Then, the balancing circuit determines whether the detection signal is an overcharged signal, and if yes, the rechargeable battery is discharged accordingly. Meanwhile, the light coupling circuit adjusts an impedance of the light coupling circuit based on the detection signal so as to break the connection between the rechargeable battery and the externally connected circuit, and the recognition circuit outputs signal identifying location of the battery.

A method of lithium-ion battery protection according to the invention controls an externally connected circuit to charge/discharge a rechargeable battery so as to prevent the rechargeable battery from over charging/discharging. The method of lithium-ion battery protection includes: first, determining whether the rechargeable battery is charging or discharging, and if charging, checking whether the average voltage of the rechargeable battery is greater than or less than the maximum charge voltage of a single battery, and if greater, charging loop is open and no charging action is taken; if the average voltage of the rechargeable battery is determined to be less than the maximum charge voltage of a single battery, then checking whether the output signal of the lithium-ion battery protection device is normal, if abnormal, charging the rechargeable battery with low current levels, if normal, charging the rechargeable battery normally; then, if the rechargeable battery is determined to be discharging, determining the average voltage of the rechargeable battery, and if the average voltage of the rechargeable battery is less than the minimum discharge voltage of a single battery, discharging loop is open and no discharging action is taken; finally, if the average voltage of the rechargeable battery is greater than the minimum discharge voltage of a single battery, discharge the battery and then check whether the output signal of the lithium-ion battery protection device is normal, if normal, continuing the discharging; if abnormal, terminating the discharging.

### BRIEF DESCRIPTION OF THE DRAWINGS

FIG. 1 shows schematic of a conventional lithium-ion battery protection device.

FIG. 2 shows schematic of the series-parallel module of a lithium-ion battery protection device according to a preferred embodiment of the present invention;

FIG. 3 shows schematic of the series-parallel module of a lithium-ion battery protection device connected in parallel with battery according to a preferred embodiment of the present invention;

FIG. 4 shows schematic of multiple serially connected lithium-ion batteries of a lithium-ion battery protection device according to a preferred embodiment of the present invention;

FIG. 5 shows schematic of multiple serially connected lithium-ion batteries of a lithium-ion battery protection device according to another preferred embodiment of the present invention;

FIG. 6 shows schematic of an externally connected circuit with multiple serially connected lithium-ion batteries of a lithium-ion battery protection device according to a preferred embodiment of the present invention;

FIG. 7 shows illustration of a lithium-ion battery protection device according to still another preferred embodiment of the present invention;

FIG. 8 shows illustration of a lithium-ion battery protection device according to yet another preferred embodiment of the present invention; and

FIG. 9 shows flow diagram of a method of lithium-ion battery protection according to a preferred embodiment of the present invention.

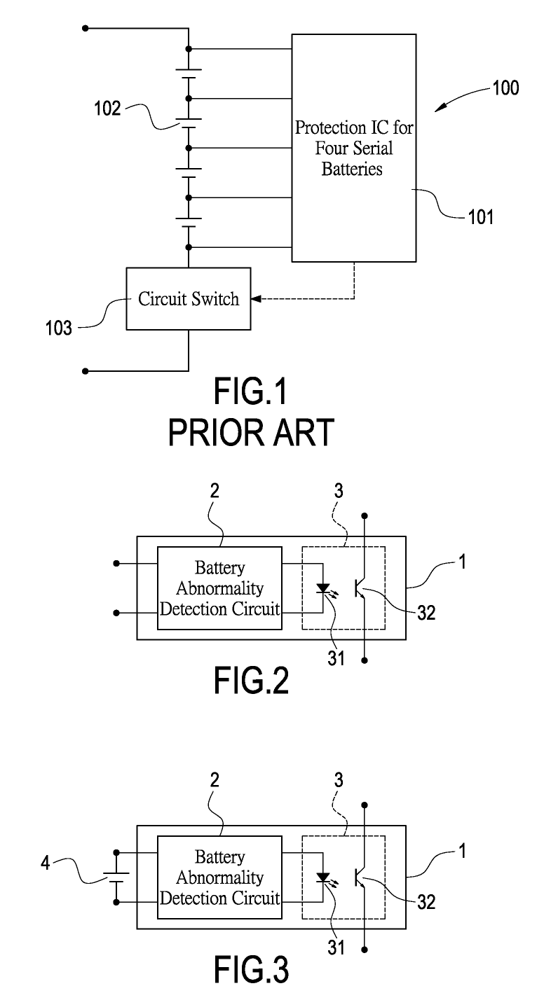

### DETAILED DESCRIPTION OF THE INVENTION

FIG. 2 and FIG. 3 respectively show schematic of the parallelly connected module of the lithium-ion battery protection device and schematic of the parallelly connected module of the lithium-ion battery protection device connected in parallel with a battery according to a preferred embodiment of the invention. In the present invention, protection device 1 includes abnormality detection circuit 2 and light-coupling circuit 3.

Abnormality detection circuit 2 is to detect the voltage of rechargeable battery 4, and output a detection signal to light-coupling circuit 3.

Light coupling circuit 3 adjusts an impedance of the light coupling circuit 3 based on the detection signal so as to either break the connection between the protection device 11 and the externally connected circuit, or cause the rechargeable battery 4 to charge or discharge.

Preferably, light coupling circuit 3 includes an LED 31 (Light Emitting Diode) and a transistor 32. LED 31 is electrically coupled to the abnormality detection circuit 2, for turning on (to emit light) or off based on the voltage of the rechargeable battery 4. Transistor 32 is electrically coupled to the externally connected circuit. The impedance of the transistor is determined based on whether the LED is emitting light. The transistor 32 is connected to or disconnected from the externally connected circuit based on its own impedance variation.

In this embodiment, when battery 4 is operating normally, abnormality detection circuit 3 outputs the detection signal of the voltage of the rechargeable batteries 4 to LED 31 of light-coupling circuit 3. The LED 31 starts to emit light after receiving the detection signal to cast light on the opposing transistor 32 such that the impedance across two ends of the transistor 32 is very low.

If battery 4 is experiencing abnormality, abnormality detection circuit 2 stops outputting signals to LED 31. Hence, LED 31 is turned off and stops to emit light, thus no light is being cast on the opposing transistor 32. The impedances across two ends of transistor 32 become so high to the extent of almost an open circuit.

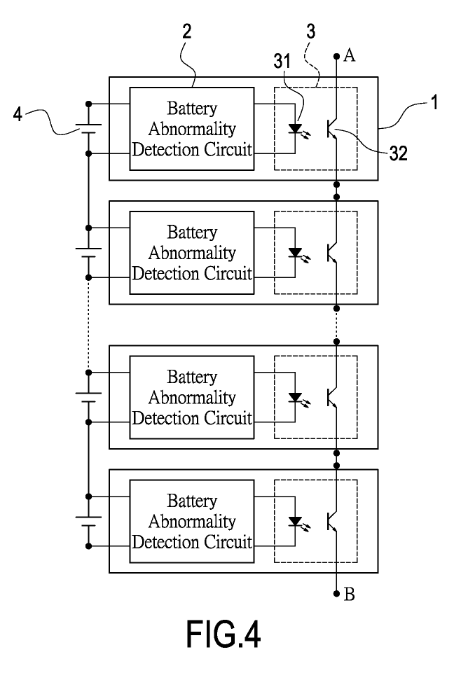

Since the two ends of light-coupling circuit 3 communicate by the illumination of light, there is no need for any electrical contact. Thus, a very good electrical insulation exists between these two ends. Taking advantage of such characteristic, as seen from FIG. 4, by serially connecting many lithium-ion batteries 4, which are parallelly connected with the battery protection module, the two ends of transistor 32 of each module are also serially connected, and the two ends of the entire array of transistors 32 are completely electrically insulated from the two ends of the entire array of lithium-ion batteries 4.

In FIG. 4, if any one of the array of battery 4 is experiencing abnormality, as mentioned above, the abnormality detection circuit 2 corresponding to said particular battery outputs a detection signal to stop the corresponding LED 32 from emitting light. Thus, the transistor 32 opposing said LED 32 does not receive any light illumination; hence, the impedance across the two ends of that transistor 32 becomes very high to the extent of nearly an open circuit. Since the array of transistors 32 are serially connected, the impedance across the two ends of the entire array of transistors 32 also becomes very high, to the extent of nearly an open circuit.

Conversely, if all the lithium-ion batteries are operating normally, the impedance across two ends of the entire array of transistors 32, namely ends A and B, becomes very low. When any one of the array of lithium-ion batteries 4 is experiencing abnormality, the impedance across points A and B becomes very high, to the extent of nearly an open circuit.

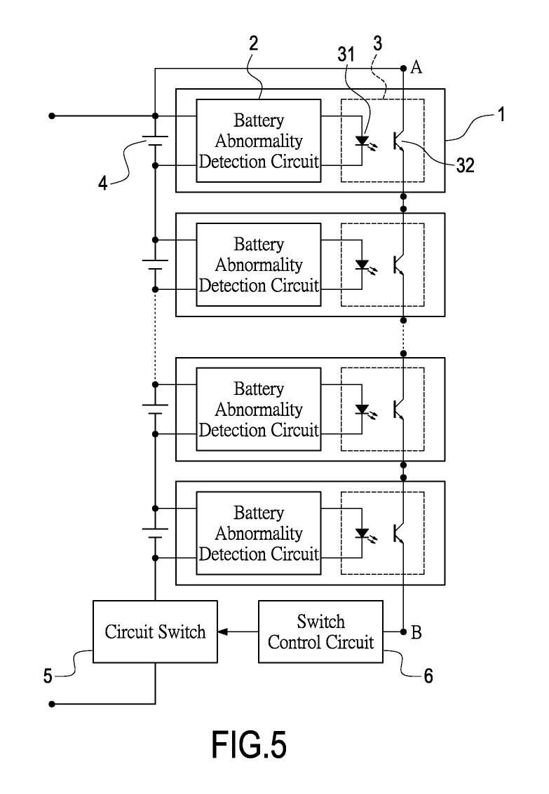

Then, taking in consideration of the impedance variation of transistors 32 across points A and B, another lithium-ion battery protection device of having multiple serially connected lithium-ion batteries can be designed, and the schematic of which is as shown in FIG. 5.

In this embodiment, circuit switch 5 and switch control circuit 6 are implemented in addition to the protection device. Switch control circuit 6 is electrically coupled to the last light-coupling circuit 3 of the array, for outputting a control signal based on the impedance of light-coupling circuit 3. Circuit switch 5 is electrically coupled to switch control circuit 6, for determining whether to charge or discharge current based on the control signal.

Thus, when the impedance across points A and B is low, circuit switch 5 is switched on to permit current flow. On the other hand, when the impedance across points A and B is high, circuit switch 5 is switched off to terminate the charging or discharging of current.

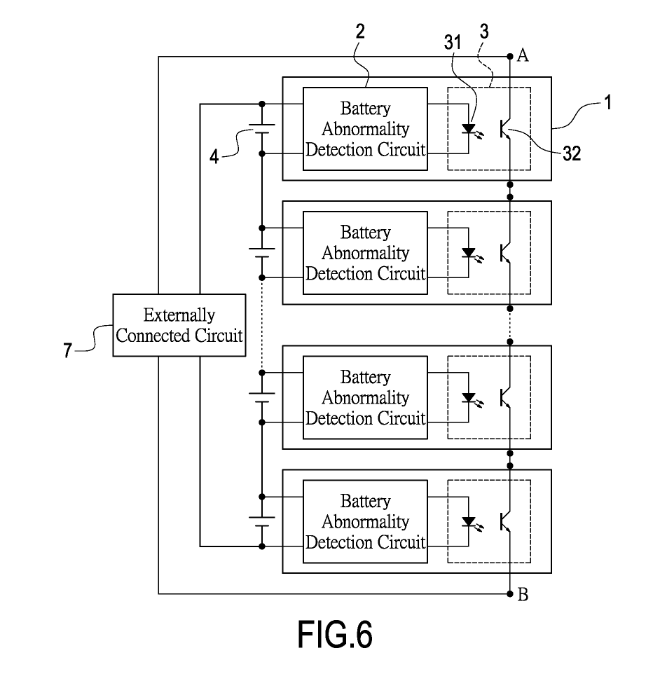

FIG. 6 shows schematic of multiple serially connected lithium-ion batteries and an externally connected circuit of the lithium-ion battery protection device according to a preferred embodiment of the invention. Points A and B are electrically coupled to the electrically connected circuit 7, which can for instance be a system or a battery charger.

In FIG. 6, abnormality detection circuit 2 informs the externally connected circuit 7 based on the impedance variation across points A and B. That is, when externally connected circuit 7 detects that the impedance across points A and B is very low, externally connected circuit 7 operates normally. However, when externally connected circuit 7 detects that the impedance across points A and B is very high, externally connected circuit 7 ceases to operate so as to terminate battery from charging or discharging.

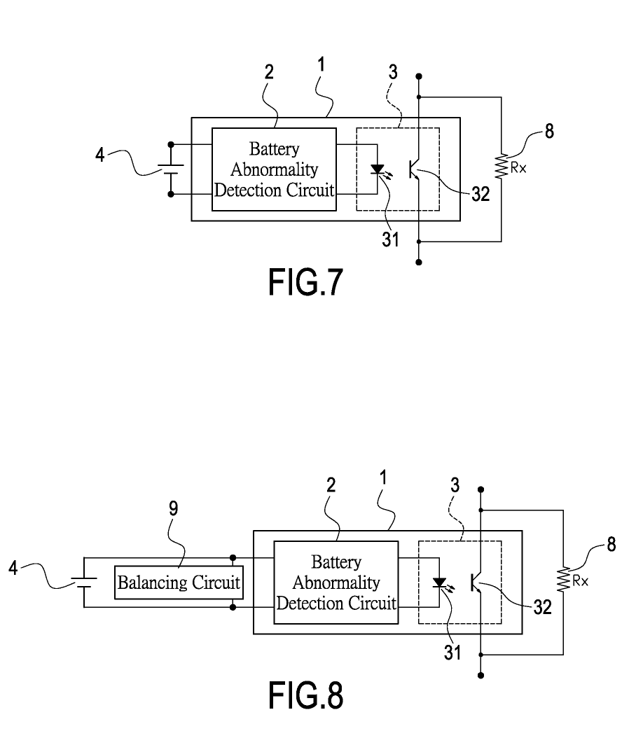

FIG. 7 shows illustration of a lithium-ion battery protection device according to another preferred embodiment of the invention. In this embodiment, a recognition circuit 8 is additionally added, which is electrically connected to light coupling circuit 3 of protection device 1. Preferably, recognition circuit 8 is an impedance value Rₓ. Light-coupling circuit 3 adjusts an impedance of light-coupling circuit 3 based on the detection signal, for breaking the connection between rechargeable battery 4 and externally connected circuit 7. At the same time, recognition circuit 8 outputs a signal (impedance value) to inform the externally connected circuit of which one in the battery 4 array is experiencing abnormality. For instance, using FIG. 4 for illustration, each light-coupling circuit 3 of protection device 1 is electrically connected to a recognition circuit 8. Each recognition circuit 8 is configured an impedance value, such as 5K, 10K, 15K, 20K Ohms etc. When light-coupling circuit 3 of the second protection device 1 in the array is open-circuited, the corresponding externally connected circuit 8 thus sees, for instance, the 10K Ohm impedance value and readily knows that the second battery is experiencing abnormality.

FIG. 8 shows illustration of a lithium-ion battery protection device according to still another preferred embodiment of the invention. In addition to electrically connecting a recognition circuit 8 to light-coupling circuit 3 of protection device 1, abnormality detection circuit 2 is also electrically connected to a balancing circuit 9. When battery 4 is overcharged, abnormality detection circuit 2 outputs a detection signal to balancing circuit 9. Balancing circuit 9 can therefore control battery 4 to initiate discharging in order to prevent damages to the batteries from overcharging.

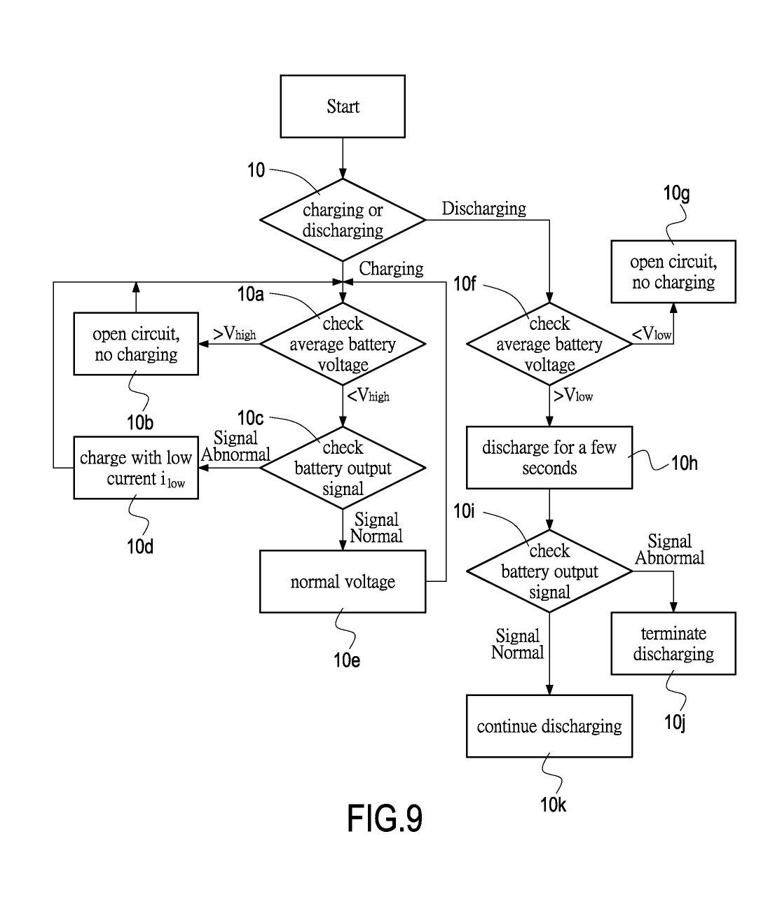

FIG. 9 shows flow diagram of a method of lithium-ion battery protection according to a preferred embodiment of the invention. First, during battery 4 charging and discharging process, a step is performed to determine whether battery 4 is charging or discharging (step 10). If the battery 4 is determined to be charging, then the method proceeds to step 10a so as to check whether the average voltage of the battery 4 is greater than V_{high} (the maximum charge voltage of a signal battery is such as 4.2V) or less than V_{high}. If greater than V_{high}, method proceeds to step 10b and charging loop is open and no charging action is taken. If the average voltage battery 4 is determined to be less than V_{high}, then step 10C is performed to check whether the output signal of the lithium-ion battery protection device is normal. If abnormal, step 10d is performed to charge battery 4 with low current levels (i_{low}). If signal is normal, step 10e is performed to charge battery 4 normally.

If battery 4 is determined to be discharging, then the method proceeds to step 10f to check the average voltage of the battery 4. If the average voltage is less than V_{low} (minimum discharge voltage of a single battery), step 10g is performed and the discharging loop is open and no discharging action is taken. If the average voltage is greater than V_{low}, then step 10h is performed to discharge for a few seconds, then step 10i is performed to check whether the output signal of the lithium-ion battery protection device is normal. If normal, step 10j is performed to continue the discharging. If abnormal, step 10k is performed to terminate the discharging.

The characteristics and the technical contents of the present invention will be explained with reference to the detailed description and the accompanying drawings. However, it should be understood that the drawings are illustrative but not used to limit the scope of the present invention.

What is claimed is:

1. A lithium-ion battery protection device, for controlling an externally connected circuit to charge/discharge a rechargeable battery so as to prevent the rechargeable battery from over charging/discharging, the lithium-ion-ion battery protection device comprising:
an abnormality detection circuit detecting a voltage of the lithium-ion-ion battery for outputting a detection signal;
a light coupling circuit, electrically coupled to the abnormality detection circuit, for adjusting an impedance of the light coupling circuit based on the detection signal so as to either break connection between the rechargeable battery and the externally connected circuit or cause the rechargeable battery to charge or discharge.

2. The lithium-ion-ion battery protection device according to claim 1, wherein the light coupling circuit comprises:
an LED (Light Emitting Diode), electrically coupled to the abnormality detection circuit, turning on to emit light or off based on the voltage detected by the abnormality detection circuit; and
a transistor, electrically coupled to the externally connected circuit, the impedance of the transistor being determined based on whether the LED is emitting light for connecting to or disconnecting from the externally connected circuit.

3. The lithium-ion-ion battery protection device according to claim 2, wherein the LED is turned on when the rechargeable battery is operating under normal conditions.

4. The lithium-ion battery protection device according to claim 3, wherein the impedance of the transistor is at a low level and the connection between the LED and the externally connected circuit is normal when the LED is turned on to emit light.

5. The lithium-ion battery protection device according to claim 2, wherein the LED is turned off to stop emitting light when the rechargeable battery is experiencing abnormality.

6. The lithium-ion battery protection device according to claim 5, wherein the impedance of the transistor is at a high level and the connection between the LED and the externally connected circuit is disconnected when the LED is turned off to stop emitting light.

7. The lithium-ion battery protection device according to claim 1, further comprising:
a switch control circuit, electrically coupled to the light coupling circuit, for outputting a control signal based on the impedance of the light coupling circuit; and
a switch, electrically coupled to the switch control circuit, for terminating the charging or discharging of current based on the control signal.

8. The lithium-ion battery protection device according to claim, 1 further comprising a recognition circuit, electrically coupled to the light coupling circuit for outputting a signal to the externally connected circuit when the light coupling circuit is open circuited, the externally connected circuit determining location of the rechargeable battery experiencing abnormality based on said signal.

9. The lithium-ion battery protection device according to claim 8, wherein the recognition circuit is an impedance value.

10. The lithium-ion battery protection device according to claim 1, further comprising a balancing circuit to be electrically coupled the abnormality detection circuit, for receiving a detecting signal output therefrom when the rechargeable battery is overcharged so as to discharge the rechargeable battery based on the detecting signal.

11. A method of lithium-ion battery protection, for controlling an externally connected circuit to charge/discharge a rechargeable battery so as to prevent the rechargeable battery from over charging/discharging, the method of lithium-ion battery protection comprising:
a) during the charging and discharging process, first determining whether the rechargeable battery is charging or discharging, and if charging, checking whether an average voltage of the rechargeable battery is greater than or less than a maximum charge voltage of a single battery, and if greater, charging loop is open and no charging action is taken;
b) if the average voltage of the rechargeable battery is determined to be less than the maximum charge voltage of a single battery in step a), then checking whether an output signal of the lithium-ion battery protection device is normal, if abnormal, charging the rechargeable battery with low current levels, if normal, charging the rechargeable battery normally;
c) determining the average voltage of the rechargeable battery if the rechargeable battery is determined to be discharging, and if the average voltage of the rechargeable battery is less than a minimum discharge voltage of a single battery, discharging loop is open and no discharging action is taken; and
d) if the average voltage of the rechargeable battery is greater than the minimum discharge voltage of a single battery in step (c), discharge the battery and then check whether the output signal of the lithium-ion battery protection device is normal, if normal, continuing the discharging; if abnormal, terminating the discharging.
